(19) United States
(12) Patent Application Publication
(10) Pub. No.: US 2025/0121523 A1
(43) Pub. Date: Apr. 17, 2025

(54) APPARATUS AND METHOD FOR CUTTING CAPSULES

(71) Applicant: SACMI COOPERATIVA MECCANICI IMOLA SOCIETA’ COOPERATIVA, Imola (BO) (IT)

(72) Inventors: Matteo VENTURINI, Imola (BO) (IT); Ruggero MENZOLINI, Imola (BO) (IT)

(21) Appl. No.: 18/727,618

(22) PCT Filed: Jan. 16, 2023
(86) PCT No.: PCT/IB2023/050357

§ 371 Date: Jul. 9, 2024

(30) Foreign Application Priority Data
Feb. 1, 2022 (IT) 102022000001727

(51) Int. Cl. B26D 1/03; B26D 7/00; B26D 7/06

(52) U.S. Cl. CPC B26D 1/03; B26D 7/06; B26D 2007/0012

(57) ABSTRACT

A cutting apparatus and method are disclosed for forming an anti-tamper opening device on a closing capsule of a container, in which the capsule engages an engagement device and rolls on a cutting device that performs at least two vertical or oblique cuts situated at a reciprocal angular distance on the relatively small capsule, performing, from when a first blade performs the first vertical or oblique cut to when a second blade performs the second vertical or oblique cut, a rotation on itself of a whole number of complete revolutions plus or less the aforesaid angular distance, arranging the two blades at a relatively great reciprocal distance.

### BACKGROUND OF THE INVENTION

The invention relates to a cutting apparatus and method of cutting capsules for closing containers, such as for example bottles, in particular for making an anti-tamper opening device in capsules of plastics.

Specifically but not exclusively, the invention relates to a cutting apparatus and method suitable for making capsules of “tethered” type, i.e. capsules that remain attached to the container even after it has been opened.

Patent publication WO 2021/186403 A1 shows a cutting method according to the preamble of the first claim and a cutting device that forms an anti-tamper opening device on a capsule and comprises at least one longitudinal blade for performing at least one circumferential cut and at least two transverse blades to perform at least two vertical or oblique cuts that are angularly spaced apart from one another by a given angle, where the angle is intended to be measured with reference to the geometric axis of the capsule.

Various aspects of the prior art are improvable. In particular, it is desirable to improve the cutting precision of the capsule so as to guarantee the formation of an anti-tamper device that conforms to specifications and is perfectly functional. It is further desirable to form an anti-tamper device by a cutting operation in which the risk is reduced of causing undesired deformation on the capsule that is such as to induce imprecisions in the formation of the anti-tamper device.

### SUMMARY OF THE INVENTION

One object of the invention is to provide an apparatus and/or a method that is able to overcome one or more of the aforesaid drawbacks of the prior art.

One object of the invention is to propose a cutting apparatus and/or a method that are alternative to those of the prior art.

One advantage is to make a constructionally simple and cheap apparatus to make an opening device on a capsule.

One advantage is to permit a precise cut to obtain an opening device that meets specifications for capsules of tethered type.

One advantage is to obtain an anti-tamper opening device that is perfectly functional for a closure capsule of a container.

One advantage is to reduce the deformations on the capsule during the cutting operation, in particular to obtain capsules of tethered type.

These objects and advantages and still others are achieved by a cutting apparatus and/or a method according to one or more of the claims set out below.

In one embodiment, a cutting method comprises the steps of advancing a capsule along an advancement path and rolling the capsule on a cutting device that comprises at least two transverse blades that perform at least two vertical or oblique cuts that are spaced apart from one another on the capsule by a set angular distance in a circumferential direction, with reference to a geometric axis of the capsule, in which the two transverse blades are arranged along the advancement path at a sufficiently great reciprocal distance so that the capsule, by rolling on the cutting device, performs a rotation on itself that is equal to one or two complete revolutions, or anyway to a whole number of complete revolutions, plus or minus the aforesaid angular distance of the cuts, from when the first transverse blade performs (in particular, starts to perform) the first vertical or oblique cut to when the second transverse blade performs (in particular, starts to perform) the second vertical or oblique cut.

The cutting method can provide in particular for the reciprocal distance of the transverse blades along the advancement path of the capsule being relatively great, i.e. greater than the reciprocal circumferential distance of the cuts performed by the blades on the side wall of the capsule, such that the performance of the first vertical or oblique cut does not interfere with the performance of the second vertical or oblique cut, and vice versa.

The aforesaid angular distance of the cuts on the side wall of the capsule is equal to an angle that is not greater than half a revolution angle, so that the capsule, by rolling on the cutting device, can perform a rotation on itself that is greater than half a revolution angle from the performance of the first vertical or oblique cut to the performance of the second vertical or oblique cut.

The aforesaid angular distance can be, in particular, an angle that is less than a third of a revolution angle, so that the capsule, by rolling on the cutting device, can perform a rotation on itself that is greater than two thirds of a revolution angle (in particular, which is equal to a complete revolution plus or minus the aforesaid angular distance) from the first vertical or oblique cut to the second vertical or oblique cut.

In one embodiment, a cutting apparatus, suitable for forming an anti-tamper opening device on a closing capsule of a container, comprises a cutting device configured to cut a capsule with at least two vertical or oblique cuts, and an engagement device configured to rotate the capsule on the cutting device so as to perform the two vertical or oblique cuts, in which the cutting apparatus is so configured that the capsule performs from when a first blade performs the first vertical or oblique cut to when a second blade performs the second vertical or oblique cut, a rotation that is greater than the aforesaid angular distance, for example a rotation that is equal to one or two complete revolutions of the capsule on itself around its axis (or a whole number of complete revolutions on itself) plus or minus the aforesaid reciprocal angular distance of the cuts on the side wall of the capsule.

The aforesaid reciprocal angular distance of the vertical or oblique cuts on the capsule can be, in particular, relatively small, for example an angular distance that is not greater than half a revolution angle and/or less than a third, or a fourth, or a fifth, or a sixth, or a seventh, or an eighth or a ninth, or a tenth, or a twelfth, or a fifteenth of a revolution angle.

The two vertical or oblique cuts could be situated in positions that are diametrically opposite one another on the capsule, i.e. at a reciprocal distance equal to half a revolution, in which case the rotation performed by the capsule, from the performance of the first vertical or oblique cut to the performance of the second vertical or oblique cut, can be the same as a whole number of complete revolutions plus half a revolution.

In one embodiment, a cutting apparatus can comprise, in particular, an engagement device configured to engage the capsule, and a cutting device configured to cut the capsule whilst the capsule rolls on the cutting device and is engaged with the engagement device so as to control rolling of the capsule, in which the cutting device comprises a first transverse blade and a second transverse blade arranged at a reciprocal distance so as to enable the engagement device to control rolling of the capsule on the cutting device so that, from when the first transverse blade performs a first vertical or oblique cut to when the second transverse blade performs a second vertical or oblique cut, the capsule performs a rotation on itself with a rotation angle greater than half a revolution angle and/or that is equal to one or two complete revolutions on itself plus or minus the reciprocal angular distance that the aforesaid vertical or oblique cuts have to have on the capsule.

The engagement device can comprise, in particular, at least one guide device comprising at least one (fixed) abutting element configured to engage the capsule (for example by friction by a friction surface and/or by meshing by a knurled or notched surface) and arranged along an advancement path of the capsule at the cutting device.

The engagement device can comprise, in particular, at least one rotating engagement member configured to engage the capsule and movable with the capsule in a feeding direction along an advancement path.

Owing to the method and/or to the apparatus in question, it is possible for the two vertical or oblique cuts, which have to be positioned on the capsule at a relatively small circumferential distance (a circumferential distance that is anyway less or at most equal to half the entire circumference of the side wall of the capsule on which the cuts are made), are made by two transverse blades positioned along the path of the capsule at a reciprocal distance, along the path of the capsule, which is relatively great (for example, a path distance that is equal to a whole multiple of the circumference of the side wall of the capsule where the cuts are made plus or minus the circumferential distance of the cuts on the side wall, in particular a path distance that is greater than at least half the circumference of the side wall of the capsule).

It has been found that owing to the proposed solution cutting precision is particularly high, so that the anti-tamper device conforms to specifications, in particular for making capsules of tethered type.

Further, it has been established that the arrangement of the two transverse blades at a relatively great reciprocal path distance enables the reciprocal interference between the various blades to be reduced that operate on the capsule and also the undesired deformation to be reduced on the capsule during the cutting operation, in particular for capsules of tethered type.

### BRIEF DESCRIPTION OF THE DRAWINGS

The invention can be better understood and implemented with reference to the attached drawings that illustrate some embodiments thereof by way of non-limiting example, in which:

FIG. 1 is a vertical raised side view of one embodiment of a cutting apparatus made according to the invention;

FIG. 2 is a section, executed along a vertical section plane of a part of the cutting apparatus of FIG. 1;

FIG. 3 is a perspective view of a cutting device used in the cutting apparatus of FIG. 1;

FIG. 4 is an exploded view of the cutting device of FIG. 3 which shows the layered structure of the device;

FIG. 5 is a top plan view of the cutting device of FIG. 3;

FIGS. 6, 7 and 8 show three components, respectively intermediate, upper and lower, of the layered structure of FIG. 4;

FIG. 9 is a bottom plan view of the cutting device of FIG. 3.

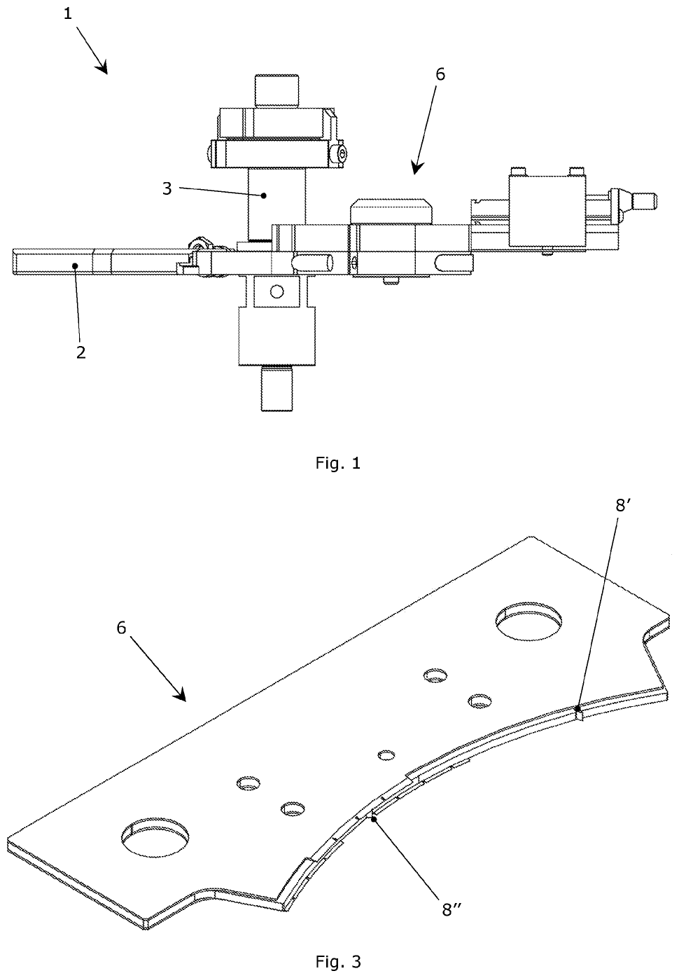

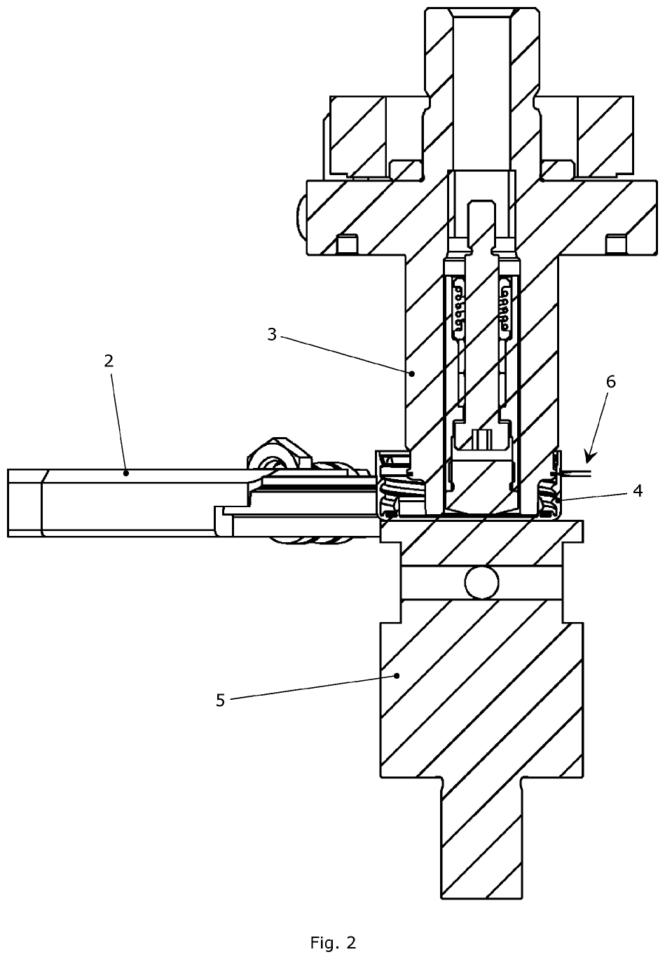

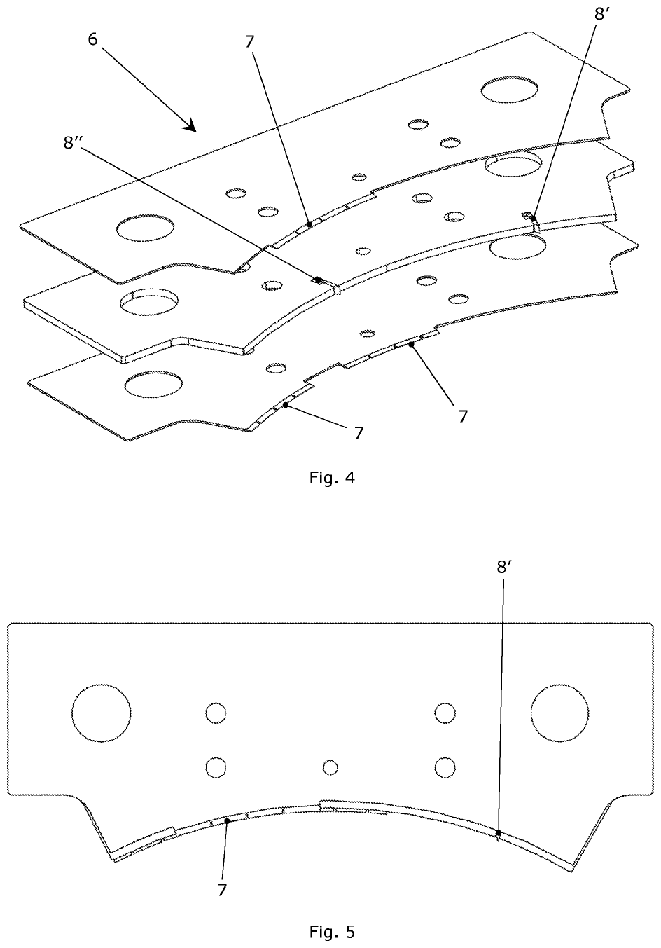

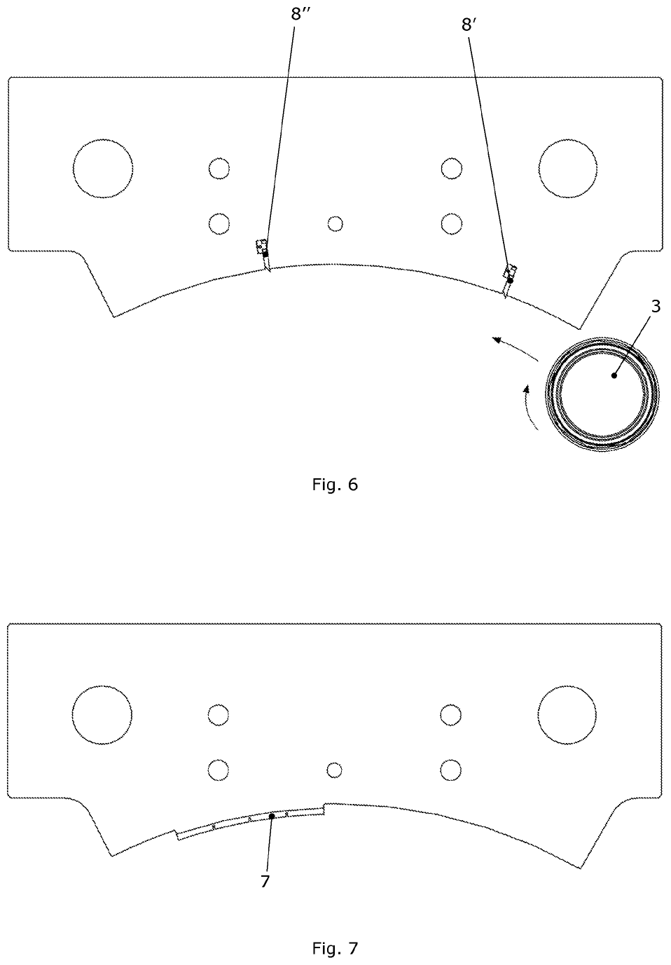

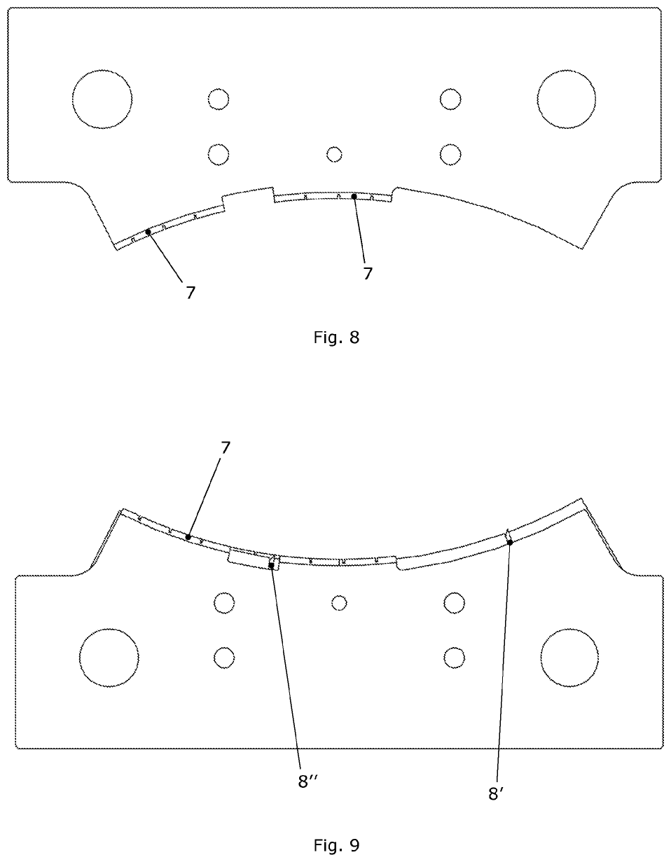

### DETAILED DESCRIPTION

With reference to the figures mentioned above, with 1, a cutting apparatus has been indicated overall. The cutting apparatus 1 can be used, in particular, to cut capsules. The cutting apparatus 1 can be used, for example, to cut capsules made of plastics. The cutting apparatus 1 can be used, in particular, to cut capsules for closing containers. The cutting apparatus 1 can be used, for example, to form a weakening line, or a preferential breaking line, in an opening device of a capsule for closing a container.

The opening device can comprise, in particular, an anti-tamper opening device that is suitable for ensuring the non-violability of the container, providing proof of the first occurred opening of the container. The cutting apparatus 1 can be used, in particular, to make an opening device for a capsule of tethered type, i.e. a capsule that remains attached to the container even after opening thereof.

The cutting apparatus 1 can comprise, in particular, an advancement path along which the capsules are fed in a feeding direction. In particular, the advancement path can lie, as in this embodiment, on a feeding plane, for example a horizontal feeding plane.

The cutting apparatus 1 can comprise, in particular, a feeder configured to feed the capsules along the advancement path. The feeder can comprise, in particular, a carousel 2 rotating around a vertical rotation axis. The carousel 2 can carry, in particular, a plurality of conveying units each of which is configured to convey a capsule.

Each conveying unit can comprise, in particular, a spindle 3 that rotates on itself (in particular around a rotation axis parallel to the rotation axis of the carousel) upon a motor-driven control and is configured to engage a capsule 4 to rotate the capsule on itself to perform at least one cut of at least one weakening line by a cutting device to form the anti-tamper opening device, in particular on a side wall of the capsule. The spindles 3 can be arranged, in particular, on the rotating spindle support carousel and can be distributed on the carousel spaced angularly apart from one another.

The advancement path of the capsules 4 can be defined by at least one portion of the circular trajectory that the rotating carousel 2 makes the spindles 3 perform that engage the capsules. Each spindle 3 can be arranged, in particular, above a lower resting base 5 of the capsule.

Each capsule 4 can comprise, in particular, a closing wall for closing a mouth of a container and a side wall for coupling with a neck of the container. Each base 5 can be configured, in particular, to engage a closing wall of the capsule 4.

Each spindle 3 can be configured, in particular, to engage the inside of the capsule 4, in particular in a hollow space defined by a side wall, or a skirt, of the capsule. The base 5 can be, in particular, rotatable around a rotation axis that is coaxial with the rotation axis of the spindle 3.

The capsule-feeder can comprise, in particular, a feeder of known type that is not described here in greater detail.

The cutting apparatus 1 can comprise, in particular, an engagement device configured to engage the capsule to roll the capsule on a cutting device 6, as will be explained further on in the description. The engagement device can comprise, in particular, at least one engagement member that is configured to engage the capsule and is susceptible of rotating around a rotation axis and which can be configured, in particular, to drag the capsule in rotation. This engagement member can comprise, as in the specific embodiment disclosed here, the spindle 3. In other embodiments, this engagement member can comprise, in particular, the lower base 5.

The engagement device can comprise, in particular, a fixed guide device that rolls the capsule that advances along the advancement path thereof, for example by coupling by friction and/or by meshing between knurling of the guide device and knurling on the capsule.

The cutting apparatus according to the present invention can comprise an engagement device configured to provoke rolling of the capsule on the cutting device by engaging a rotating engagement member and/or by engaging a fixed guide device.

The engagement member (in this example, the spindle 3) can be, in particular, rotatable by motor means around its rotation axis (for example by motor means that rotate the carousel 2, by mechanical transmission that connects the rotation axis of the carousel to the rotation axes of the various engagement members) and can be configured to engage inside a concave portion of the respective capsule 4. The rotation axes of the various engagement members can be parallel to one another and parallel to the carousel axis around which the carousel is rotatable by a motor drive.

The cutting apparatus 1 can comprise, in particular, a cutting device 6 configured to form at least one weakening line on a capsule fed by the feeder along the advancement path. The cutting device 6 can be, in particular, configured so as to cut the capsule 4 whilst the capsule rolls on the cutting device 6 and is engaged with the engagement device (for example with the spindle 3 and/or with the fixed guide device).

The cutting device 6 can comprise, in particular, one or more longitudinal blades 7 configured to perform on the capsule one or more circumferential cuts. The cutting device 6 can comprise, in particular, at least one first transverse blade 8′ configured to perform on the capsule at least one first vertical or oblique cut. The cutting device 6 can comprise, in particular, at least one second transverse blade 8″ configured to perform on the capsule at least one second vertical or oblique cut. In the illustrated embodiment, the two transverse blades 8′ and 8″ are configured to perform on the capsule two respective vertical cuts. It is however possible to use transverse blades configured to perform oblique cuts or cuts that are partially vertical and partially oblique.

The two transverse blades 8′ and 8″ can be, in particular, so configured that the two vertical or oblique cuts performed on the capsule are situated at a reciprocal circumferential distance on the side wall of the capsule that corresponds to a reciprocal angular distance of an angle that is not greater than a half a revolution angle and/or less than a third, or a fourth, or a fifth or a sixth or a seventh or an eighth, of a revolution angle in a circumferential direction, with reference to an axis of the capsule.

The first vertical or oblique cut and the second vertical or oblique cut performed on the capsule 4 can be, in particular, still nearer one another, for example angularly spaced apart from one another by an angle less than a twentieth or a fifteenth, or a twelfth, or a tenth, or a ninth of a revolution angle in a circumferential direction, with reference to a geometric axis of the capsule.

It is nevertheless possible for the two vertical or oblique cuts to be situated diametrically opposite one another on the side wall of the capsule, i.e. spaced between one another by half a revolution angle.

The cutting apparatus 1 can comprise, in particular, a control unit (for example, electronic and programmable) configured to control the feeder by advancing the capsule along the advancement path, in particular a control unit configured to control the feeder rotating the engagement member on itself around its rotation axis.

The control unit can be configured, in particular, to control the feeder by rolling the capsule 4 on the cutting device 6 to make the weakening lines.

The control unit can be configured, in particular, such that the engagement device (arranged for controlling rolling of the capsule) make the capsule rotate on itself by more than the reciprocal angular distance of the cuts on the capsule, from when the first transverse blade 8′ performs the first vertical or oblique cut to when the second transverse blade 8″ performs the second vertical or oblique cut.

The first transverse blade 8′ and the second transverse blade 8″ can be arranged along the advancement path, in particular, at a relatively great reciprocal distance and such as to enable the capsule 4, when the engagement device is engaged (for example, with the spindle 3 and/or with the fixed guide device), to roll (in particular, to roll without sliding) on the cutting device 6 performing a rotation on itself equal to an entire number of complete revolutions plus or minus the reciprocal angular distance that the cuts will make on the capsule and/or performing a rotation on itself that is greater than the reciprocal angular distance that the cuts will have on the capsule, considering the path of the capsule in the period between performing two vertical or oblique cuts, i.e. from when the first transverse blade 8′ performs the first vertical or oblique cut to when the second transverse blade 8″ performs the second vertical or oblique cut, in particular from the moment in which the first transverse blade 8′ starts to perform the first vertical or oblique cut to the moment in which the second transverse blade 8″ starts to perform the second vertical or oblique cut, or from the moment in which the first transverse blade 8′ ends performing the first vertical or oblique cut to the moment in which the second transverse blade 8″ ends performing the second vertical or oblique cut.

The arrangement of the transverse blades 8′ and 8″ at a relatively great distance on the path of the capsule can also be provided in cases in which rolling of the capsule is guided by fixed guide means.

It is in particular possible to provide for rotation on itself performed by the capsule around its axis, from when the first transverse blade 8′ performs the first vertical or oblique cut to when the second transverse blade 8″ performs the second vertical or oblique cut, being greater than at least half a revolution angle, i.e. for the second vertical or oblique cut being performing after the capsule, which rolls on the cutting device, has performed more than half a complete revolution on itself, starting from when the first vertical or oblique cut has been performed.

It is nevertheless possible for the capsule to perform, in the period that elapses between performing the two vertical or oblique cuts, a whole number of complete revolutions plus or minus the set distance that there may be between the two vertical or oblique cuts on the capsule.

The advancement path can comprise, in particular, at least one circular portion (defined by the rotation of the carousel 2). The first transverse blade 8′ and the second transverse blade 8″ can be arranged, in particular, along the aforesaid circular portion at an angular distance from one another that is greater than 5 sexagesimal degrees, with reference to a geometric centre of the circular portion (in particular, to the rotation axis of the carousel 2).

The first transverse blade 8′ and the second transverse blade 8″ can be arranged, in particular, along the circular portion at a reciprocal angular distance that is greater than 10 sexagesimal degrees, or greater than 15 sexagesimal degrees, or greater than 20 sexagesimal degrees, or greater than 25 sexagesimal degrees, or greater than 30 sexagesimal degrees, with reference to the geometric centre of the circular portion.

The cutting device 6 can comprise, in particular, at least two longitudinal blades 7 configured to perform at least two circumferential cuts on the capsule. The two longitudinal blades 7 can be arranged, respectively, on at least two geometric planes that are parallel to and spaced apart from one another.

The two transverse blades 8′ and 8″ can be, in particular, arranged in a space comprised between the two aforesaid geometric planes. The first transverse blade 8′ can be arranged, in particular, before the start point of any longitudinal blade 7 (with reference to the feeding direction of the capsule along the advancement path). The second transverse blade 8″ can be arranged, in particular (as in this example), after the start point of the first longitudinal blade 7 (i.e. the longitudinal blade that first meets the capsule 4) and before the end point of the last longitudinal blade 7 (i.e. the longitudinal blade that last leaves the capsule 4).

Each longitudinal blade 7 can comprise, in particular, a relatively thin metal lamina, with two dimensions (width and length) that is significantly greater than the third dimension (thickness).

Each longitudinal blade 7 can be configured, in particular, to form a weakening line with a circumferential extent, or at least partially circumferential extent, owing to the fact that the capsule is fed rotating on itself. Each longitudinal blade 7 can be configured, in particular, to form a weakening line defined by a plurality of bridges with facilitated fracture that are spaced angularly apart from one another.

Each longitudinal blade 7 can comprise, in particular, at least one cutting edge that is discontinuous because of the presence of a plurality of chambers or recesses. Each longitudinal blade 7 can comprise, in particular, at least one cutting edge in the shape of a circumferential arc (for example lying on a cutting plane parallel to a plane of the advancement path of the capsules).

The engagement device and the cutting device 4 can be so configured, in particular, that a capsule, when it is fed to the cutting device 4 by the feeder, can roll (in particular on detecting means of the cutting device 4) whilst the blades 7, 8′ and 8″ perform the respective cuts on a side wall of the capsule to form the anti-tamper opening device.

In this example, an apparatus with two transverse blades 8′ and 8″ has been disclosed, even if it is possible to use three or more transverse blades.

In operation, the cutting apparatus can actuate a cutting method for cutting a closing capsule of a container to form an anti-tamper opening device, in which the capsule 4 rolls on the cutting device 6 and can be engaged with an engagement device that controls rolling of the capsule that advances along the advancement path.

The blades 7, 8′ and 8″ can perform on the capsule, whilst the capsule 4 rolls on the cutting device 6, respectively least one circumferential cut, at least one first vertical or oblique cut and at least one second vertical or oblique cut, in which the first vertical or oblique cut and the second vertical or oblique cut can be angularly spaced apart from one another, on the side wall of the capsule, by a determined angle in a circumferential direction, in which the reciprocal circumferential distance of the cuts will be relatively small and anyway not greater than half the circumference of the side wall of the capsule on which the cuts are made.

The capsule can be induced to perform a rotation that is greater than half a revolution angle (and/or the same as a whole number of complete revolutions plus or minus the reciprocal angular distance of the cuts on the capsule) around the axis of the capsule from when the first transverse blade 8′ performs the first vertical or oblique cut to when the second transverse blade 8″ performs the second vertical or oblique cut.

In practice, feeding the capsule 4 and configuring the cutting device 6 are coordinated together so that the second vertical or oblique cut is performed after the capsule has performed a rotation that is about a complete revolution (or a whole number of complete revolutions) with a difference, more or less, due to the fact that the two vertical or oblique cuts must not be superimposed on one another but be positioned at a preset distance (reciprocal distance that is in general relatively small).

In this manner, it is possible to arrange the two transverse blades 8′ and 8″ at a reciprocal distance, considered along the path of the capsules 4, that is relatively great, so that the cut performed by a transverse blade does not disturb and does not interfere with the cut performed by the other transverse blade, eliminating the risk of imprecisions, deformations and other errors due to the reciprocal movement that could influence cutting operations performed by the two transverse blades 8′ and 8″.

If the rolling of the capsule is guided by a rotating engagement device, the method may involve setting up the transverse blades 8′ and 8″ at an appropriate reciprocal distance and controlling the rotating engagement device (for example, the spindle 3) making it perform a relatively high rotation (greater than the reciprocal angular distance of the cuts on the capsule) from when the first transverse blade 8′ performs the first vertical or oblique cut to when the second transverse blade 8″ performs the second vertical or oblique cut.

If the rolling of the capsule is guided by a fixed engagement device (for example by a guide device by friction and/or meshing), the method can set up the transverse blades 8′ and 8″ at an appropriate reciprocal distance so that the capsule, which rolls guided by the engagement device (in particular without sliding), performs a relatively high rotation (greater than the reciprocal angular distance of the cuts on the capsule) from when the first transverse blade 8′ performs the first vertical or oblique cut to when the second transverse blade 8″ performs the second vertical or oblique cut.

1. Cutting method for cutting a container closing capsule to form an opening device, wherein the capsule rolls on a cutting device which comprises at least one longitudinal blade, at least one first transverse blade and at least one second transverse blade, wherein said blades make on the capsule, while the capsule rolls on said cutting device, respectively at least one circumferential cut, at least one first vertical or oblique cut and at least one second vertical or oblique cut, said first vertical or oblique cut and said second vertical or oblique cut being angularly spaced apart from each other by an angular distance in a circumferential direction, with reference to a geometric axis of the capsule, wherein said capsule performs a rotation greater than said angular distance around said geometric axis while rolling on said cutting device from when said first transverse blade performs said first vertical or oblique cut to when said second transverse blade performs said second vertical or oblique cut.

2. Method according to claim 1, wherein said capsule-rotates on itself around its own axis from when said first transverse blade performs said first vertical or oblique cut to when said second transverse blade performs said second vertical or oblique cut, said rotation being equal to a whole number of complete revolutions on itself, in particular one or two complete revolutions, plus or minus said angular distance.

3. Method according to claim 1 or 2, wherein said first vertical or oblique cut and said second vertical or oblique cut are angularly spaced from each other by an angle not greater than half a turn in said circumferential direction, and wherein said capsule performs a rotation greater than half a turn around said geometric axis while rolling on said cutting device from when said first transverse blade performs said first vertical or oblique cut to when said second transverse blade performs said second vertical or oblique cut, in particular from when said first transverse blade ends execution of said first vertical or oblique cut to when said second transversal blade starts execution of said second vertical or oblique cut.

4. Method according to claim 3, wherein said first vertical or oblique cut and said second vertical or oblique cut are angularly spaced from each other by an angle of less than one third of a round angle in said circumferential direction, and said capsule completes a rotation greater than two thirds of a round angle around said geometric axis while rolling on said cutting device from when said first transverse blade performs said first vertical or oblique cut to when said second transverse blade performs said second vertical or oblique cut, in particular from when said first transverse blade ends the execution of said first vertical or oblique cut to when said second transverse blade starts the execution of said second vertical or oblique cut.

5. Method according to claim 1, wherein said capsule performs a rotation greater than a round angle around said geometric axis while rolling from when said first transverse blade performs said first vertical or oblique cut to when said second transverse blade performs said second vertical or oblique cut.

6. Method according to claim 1, wherein said capsule is engaged with an engagement device as it rolls on said cutting device, said engagement device causing said capsule to perform the desired rotation around said geometric axis from when said first transverse blade performs said first vertical or oblique cut to when said second transverse blade performs said second vertical or oblique cut; said engagement device comprising at least one fixed guide device and/or at least one rotating engagement member.

7. Method according to claim 1, wherein said at least one circumferential cut, said at least one first vertical or oblique cut and said at least one second vertical or oblique cut are configured to form an opening device for a tethered-type capsule.

8. Cutting apparatus for making an opening device for capsules, said cutting apparatus comprising:
a feeder configured to feed at least one capsule along a feed path;
a cutting device arranged along said feed path for cutting the capsule while the capsule rolls on said cutting device, said cutting device comprising at least one longitudinal blade for making at least one circumferential cut on the capsule, at least one first transverse blade for making at least one first vertical or oblique cut on the capsule, and at least one second transverse blade for making at least one second vertical or oblique cut, said first vertical or oblique cut and said second vertical or oblique cut being spaced apart by a determined angular distance in a circumferential direction, with reference to a geometric axis of the capsule;
an engagement device configured to engage the capsule and control the rolling of the capsule on said cutting device;
a control unit configured to control said engagement device so as to cause the capsule to perform a rotation greater than said determined angular distance around its own geometric axis, from when said first transverse blade makes said first vertical cut or oblique to when said second transverse blade makes said second vertical or oblique cut, said at least one first transverse blade and said at least one second transverse blade being arranged along said feed path at a mutual distance such as to allow the capsule to roll, without slipping on said cutting device from when said first transverse blade makes said first vertical or oblique cut to when said second transverse blade makes said second vertical or oblique cut.

9. Apparatus according to claim 8, wherein said control unit is configured to control said engagement device so that the capsule, while rolling, performs, from when said first transverse blade makes said first vertical or oblique cut to when said second blade transversal makes said second vertical or oblique cut, a rotation equal to a whole number of complete turns on itself around its own axis plus or minus said angular distance between said first vertical or oblique cut and said second vertical cut or oblique.

10. Apparatus according to claim 8, wherein said feed path comprises at least one circular portion and wherein said first transverse blade and said second transverse blade are arranged along said at least one circular portion at an angular distance from each other greater than five sexagesimal degrees, with reference to a geometric center of said circular portion.

11. Apparatus according to claim 8, wherein said cutting device comprises at least two longitudinal blades for performing at least two circumferential cuts on the capsule, said at least two longitudinal blades being arranged, respectively, on two parallel geometric planes and spaced apart from each other, said at least two transversal blades being arranged in a space between said two geometric planes.

12. Apparatus according to claim 8, wherein said engagement device comprises at least one fixed guide device configured to engage with the capsule rolling on said cutting device by frictional fit and/or by meshing.

13. Apparatus according to claim 8, wherein said engagement device comprises at least one spindle, which is operable in rotation on itself about an axis of rotation and which is configured to engage within a concave portion of the capsule.

14. Apparatus according to claim 8, wherein said feeder comprises a carousel carrying a plurality of engagement members each of which is configured to engage with a respective capsule and is capable of rotating around a respective rotation axis, the rotation axes of the various engagement members being parallel to each other and to a carousel axis around which said carousel is rotatable.
